(19) United States
(12) Patent Application Publication
(10) Pub. No.: US 2017/0124890 A1
(43) Pub. Date: May 4, 2017

(54) INTERACTIVE TABLE

(71) Applicant: Robert W. Soderstrom, Los Angeles, CA (US)

(72) Inventor: Robert W. Soderstrom, Los Angeles, CA (US)

(21) Appl. No.: 15/339,776

(22) Filed: Oct. 31, 2016

Related U.S. Application Data
(60) Provisional application No. 62/248,867, filed on Oct. 30, 2015.

(51) Int. Cl. G09B 5/02; G06T 19/00

(52) U.S. Cl. CPC G09B 5/02; G06T 19/006; G06F 3/0482

(57) ABSTRACT

An interactive table created with textured stones from around the world. More specifically, a table having a digital interactive interface and surrounding walls that become digital panels. The table can be accompanied by a mobile application that provides individuals with augmented reality viewing of the table and educational information on each textured stone that is part of the table. The mobile application can allow individuals to upload content, such as pictures, and the application can trigger a display of the content by activating technology linked to the table.

### CROSS-REFERENCE TO RELATED APPLICATION

This application claims priority to U.S. Provisional Application No. 62/248,867, filed Oct. 30, 2015 and titled INTERACTIVE TABLE.

### FIELD OF THE DISCLOSURE

The present invention generally relates to the field of interactive, educational tools. More specifically, the present invention relates to the field of educating and inspiring individuals by using sculpture and interactive media elements.

### BACKGROUND OF THE INVENTION

Individuals in today's population are more interconnected than ever. However, the accessibility of technology to keep individuals interconnected has not dissipated civil rights issues and human rights issues that linger throughout various countries. Therefore, something is needed that reminds people of the importance of global human rights and that encourages individuals to accept each other and work together.

### SUMMARY OF THE INVENTION

The present invention is an interactive table created with textured stones from around the world. The table can be part of a larger interactive exhibit within its surrounding space, wherein the table itself can be a digital interactive interface and the walls of the space can become lively digital panels. Additionally, the table can be accompanied by a mobile application that provides individuals with augmented reality viewing of the table and educational information on each textured stone that is part of the table. Further, the mobile application can allow individuals to upload content, such as pictures, and the application can trigger a display of the content by activating technology linked to the table.

### BRIEF DESCRIPTION OF THE DRAWINGS

FIG. 1 illustrates a top view of one embodiment of the interactive table.

FIG. 2 illustrates a top view of one embodiment of the interactive table.

FIG. 3 illustrates a portion of the interactive table according to one embodiment of the present invention.

FIG. 4 illustrates an interactive table according to one embodiment of the present invention.

FIG. 5 illustrates an interactive table according to one embodiment of the present invention.

FIG. 6 illustrates an interactive table according to one embodiment of the present invention.

FIG. 7 illustrates a user interaction with the interactive table according to one embodiment of the present invention.

FIG. 8 is a schematic block diagram depicting an example computing system used in accordance with one embodiment of the present invention.

### DETAILED DESCRIPTION

Various embodiments will be described in detail with references to drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

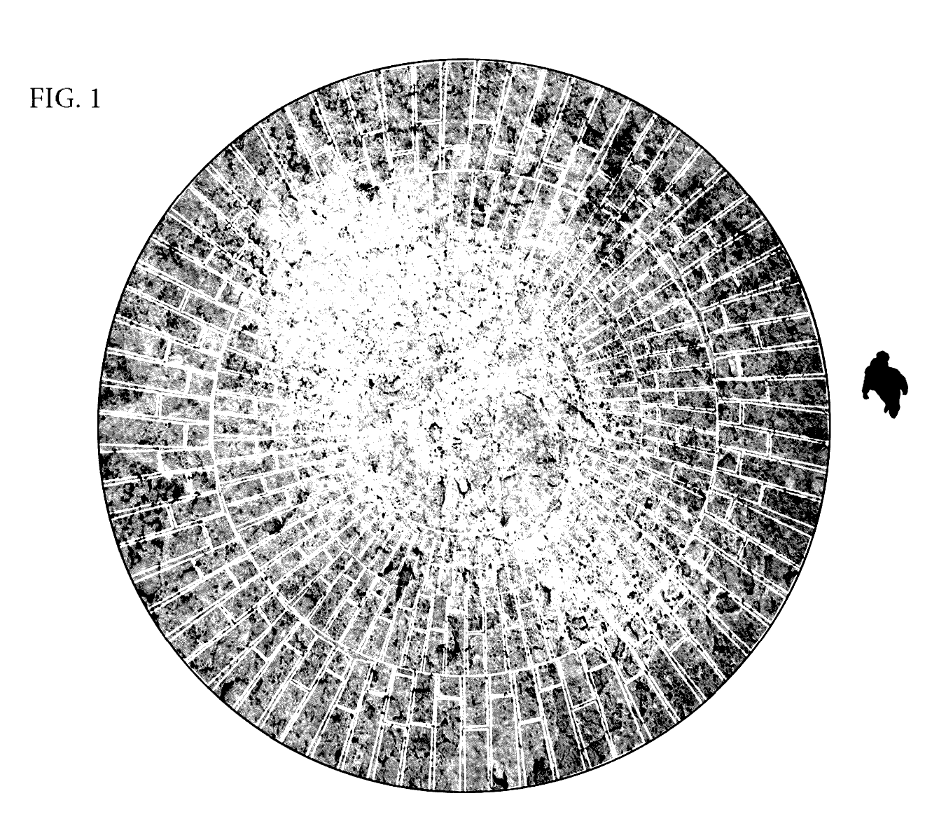

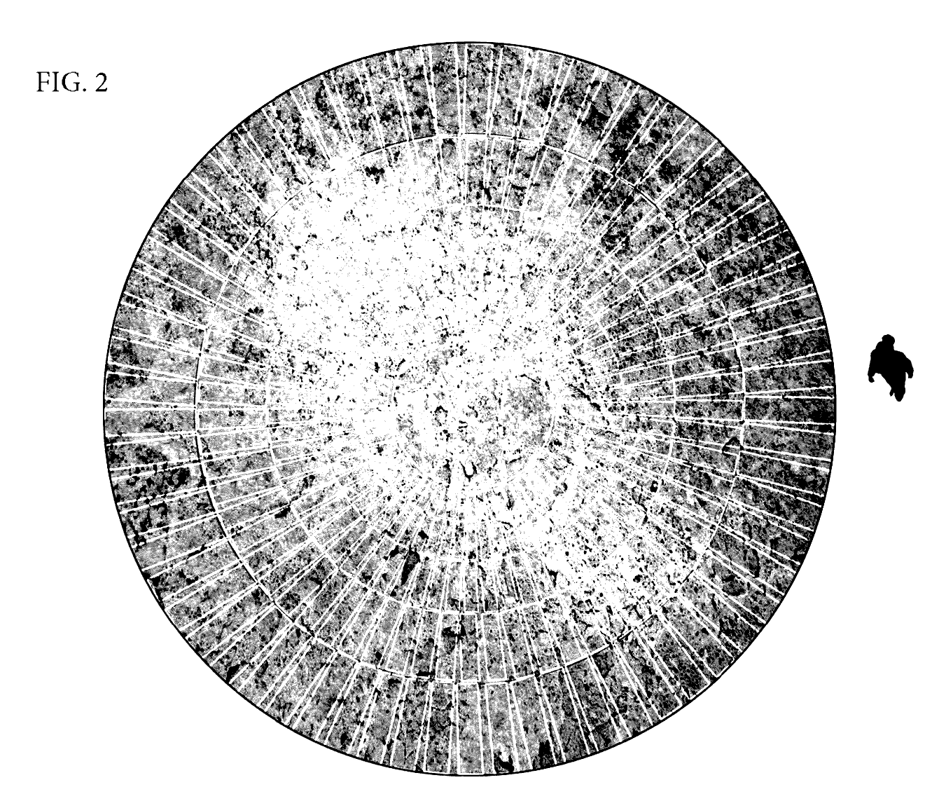

Generally, the disclosed invention includes a large, low, circular stone table comprised of stones from every country in the world, as illustrated in FIGS. 1 and 2. More specifically, each stone can originate from a place of geologic, cultural or emotional significance to a nation's people and their journey. Further, each nation can have a local artist engrave the stone, or the word “hope” may be engraved on each stone in that nation's language. Therefore, the engraved stones representing every country in the world may be produced with materials indigenous to each nation's own lands. For example, the stone from Greece may be sourced from the grounds of the Acropolis while the stone from South Africa can be sourced from the Robben Island prison cell that held Nelson Mandela.

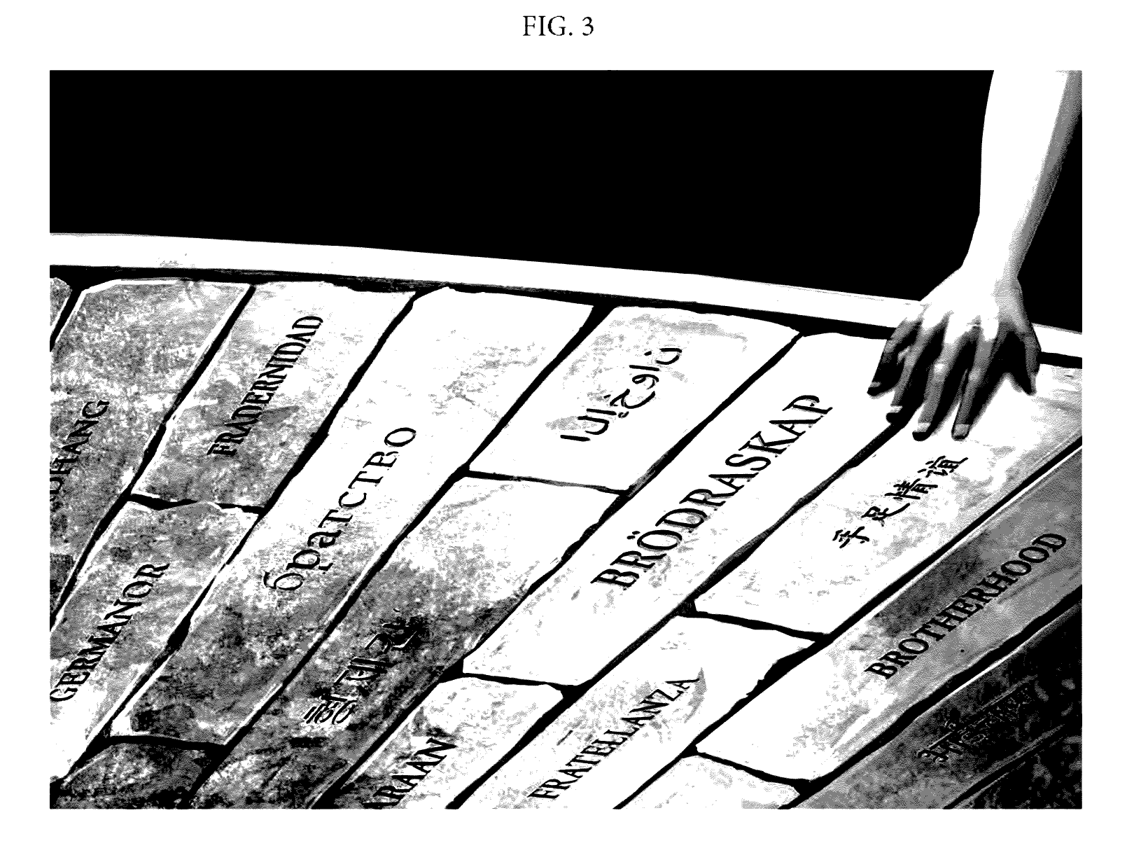

The table may be approximately ten yards in diameter, and each of the representative stones can have the word “Hope” or “Brotherhood” inscribed in that nation's language, as illustrated in FIG. 3. Therefore, the table may be a physical reminder of President Obama's election night speech in which he said “It's the answer that led those who have been told for so long by so many to be cynical, and fearful, and doubtful of what we can achieve to put their hands on the arc of history and bend it once more toward the hope of a better day.” Alternatively, the table may be a real-world manifestation of Martin Luther King's 1963 speech that, “I have a dream that one day . . . the sons of former slaves and sons of former slave-owners will sit down together at the table of brotherhood,” and celebrates advancements in civil rights and human rights by encouraging individuals to gather and circulate around the all-inclusive table.

For example, the combination of the table and its surrounding space can result in a powerful and inspiring monument that connects the history of civil rights, especially American civil rights, with the broader goal of global human rights. In this regard, the table and surrounding space can inspire national and international visitors alike and can be an acknowledgement of hopeful spirit and positive impact.

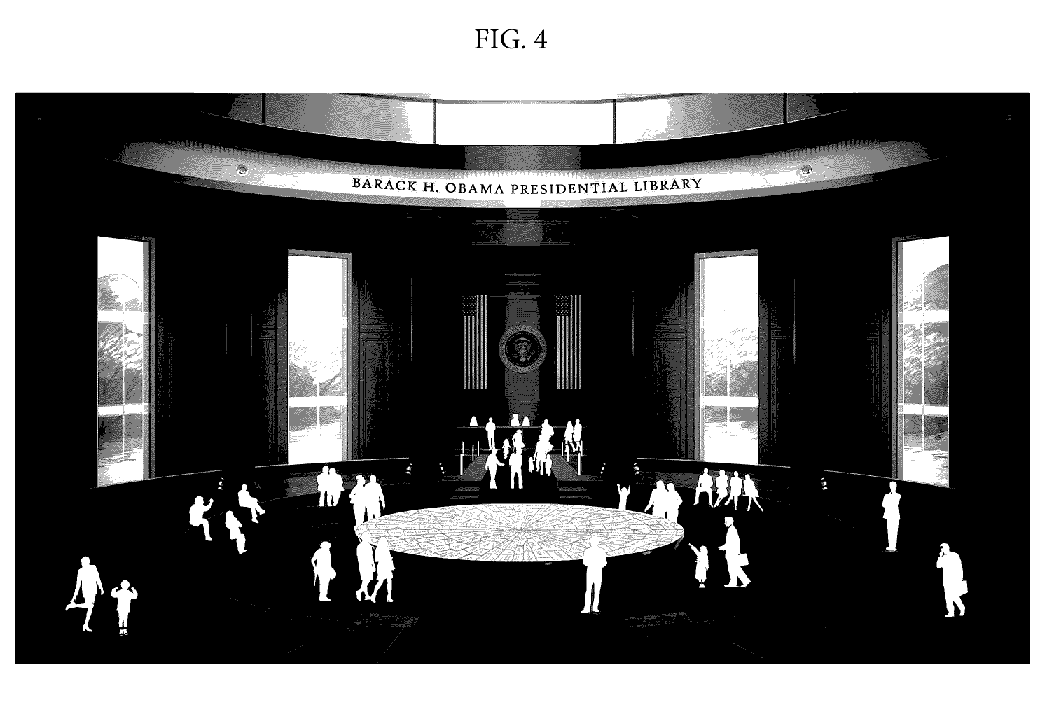

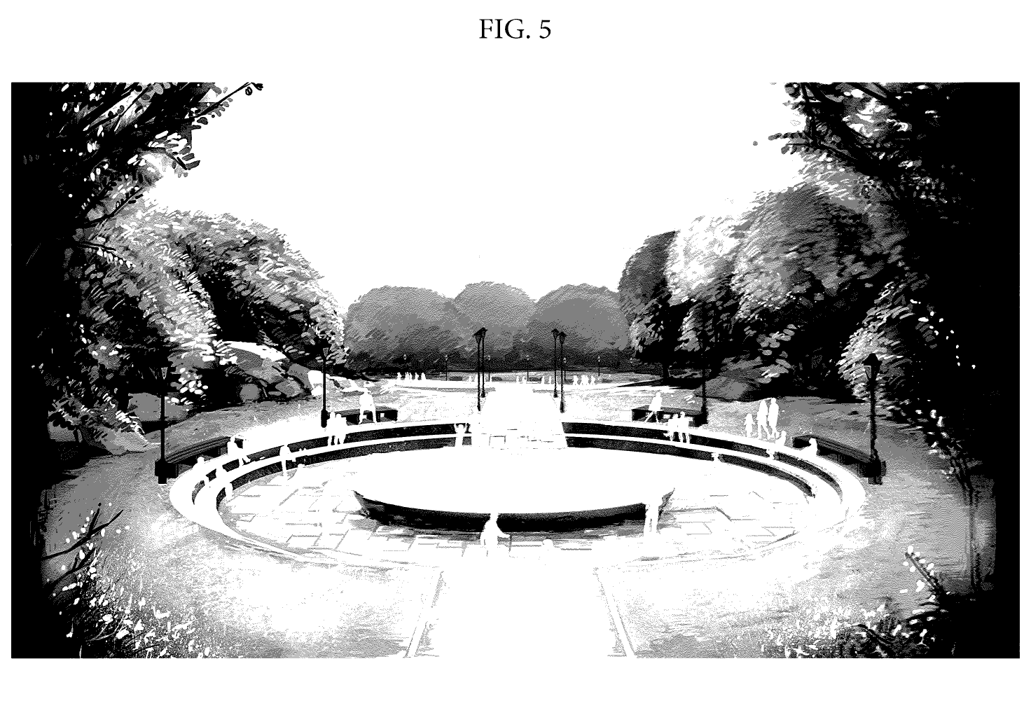

The space used to integrate the table can be indoors or outdoors and can be a representation of any architectural style. For example, the space can be located in a library, such as the Barack H. Obama Presidential Library as illustrated in FIG. 4, or a park, such as Jackson Park or Washington Park in Chicago, as illustrated in FIG. 5. The table, if located in a park, can rise organically from the park in a way that invites visitors to walk around it, feel the stones, and view the table in appreciation and meditation.

In some embodiments, the table can be part of a larger interactive exhibit within its surrounding space. More specifically, marrying the ancient stones to modern times, the walls of the space can become lively digital panels that permit social media interplay and digital prayers for world peace. Additionally, visitors can walk around the table and read and feel the textured stones from around the world, and they may insert folded paper prayers or flowers into the crevices around a particular nation's stone.

Alternatively, an electronic touch screen could be laid over the top of the stones to create a digital version of the table. The digital stones could mimic the actual stones and remain in the same configuration as the actual stones. However, the digital stones can be digitized and interactive. In another embodiment, an interactive glass screen could be laid on top of any flat surface and could mimic the stones and their configuration. Therefore, a space may include both the stone table having geologically and culturally significant stones as well as the interactive, digital table. In one example of an interactive user experience, a user could touch a stone (or a representation of a stone) on the table and see or hear a digital response on a surrounding wall. For example, touching a digital stone for Bulgaria could activate panels on the wall with a live feed of people in Bulgaria or video and information about Bulgaria. In another example, the table can be activated to show a film that is coordinated with the walls surrounding the table. In that way, the room can have pre-filmed video and real-time digital interactions with people from around the world and can operate like a theater that invites people to participate with the table.

In some embodiments, a mobile application can allow people from around the world to see how the table is being interactive with by real-time visitors. For example, a schoolroom or person in Seoul can pull up the mobile application at any time to see how people are touching the table in a separate city or country, for example, Chicago or Washington D.C. Further, the table can sync with software to track usage and analyze data about how many times visitors touch and interactive with the various parts of the table. In some embodiments, each digital stone can have its own in-country phone number, and people can tweet or text messages to that stone. Therefore, real-world visitors at the table can stand and watch the messages arrive on the stone from people in the corresponding country. Since the stones will represent all countries, and will therefore span all time zones, each stone may have more activity at specific points of time during the day.

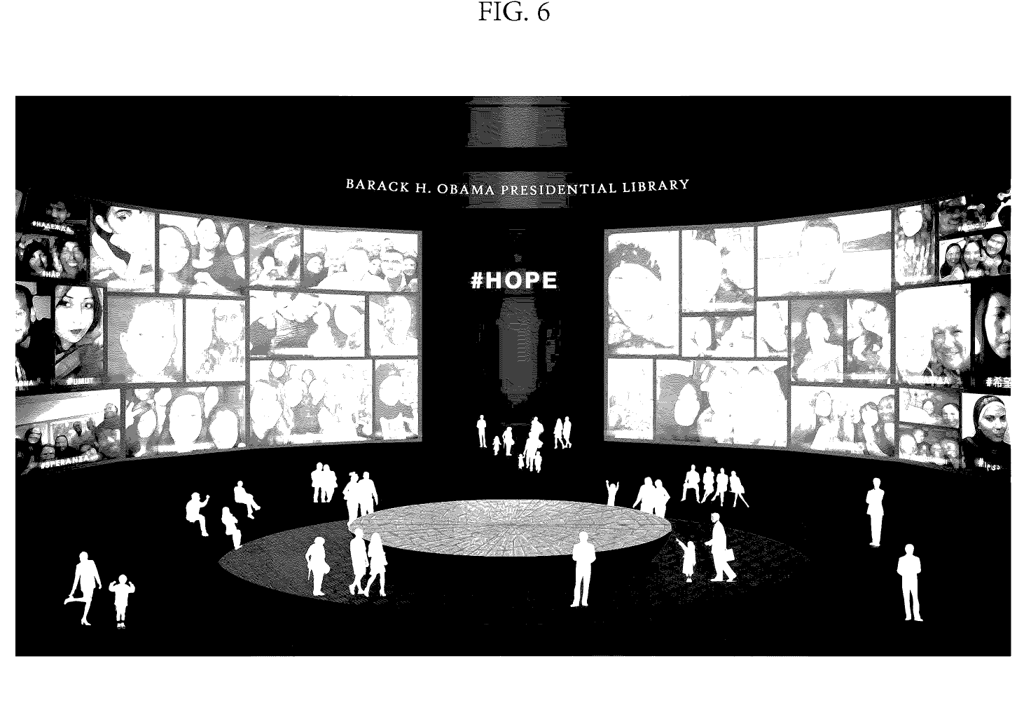

In addition to interaction with the table, the space that holds the table can have a digital, interactive interface that enables visitors to post photos and messages on the walls around the table, as illustrated in FIG. 6. For example, the table and the surrounding space can be assigned contact information such as an email address, a label or metadata tag such as a hashtag, and a phone number. This contact information, such as message@tableofhope.org, message@tableofbrotherhood.org, #tableofhope, #tableofbrotherhood, #TOH, #TOB, 773.TEXT.HOPE, and 773.TEXT.PEACE, may be used by people to send photographs and virtual messages, which the interactive interface can receive and display on the walls around the table.

More specifically, the digital interface can receive photographs of visitors or their friends and loved ones when the label or metadata tag is used on a social networking site, when the photograph is texted to the designated phone number, or when the photograph is sent to the designated email. These communication methods can be monitored by the digital interface and it can automatically pull received messages and photographs from the recipient account and display them on the walls for visitors to see. Schoolchildren from around the world can be asked to draw their own pictures, which can also be uploaded or sent using the contact information so they appear on the walls surrounding the table. All submitted images and messages can be uploaded and retained at a designated online website that is connected to the table and the surrounding space. Therefore, the space can act as a living receiver of real-time images, messages, and texts of hope from around the world. The images and messages can also sync to a live feed on social media, where the digital community can gather at any time for hope and inspiration.

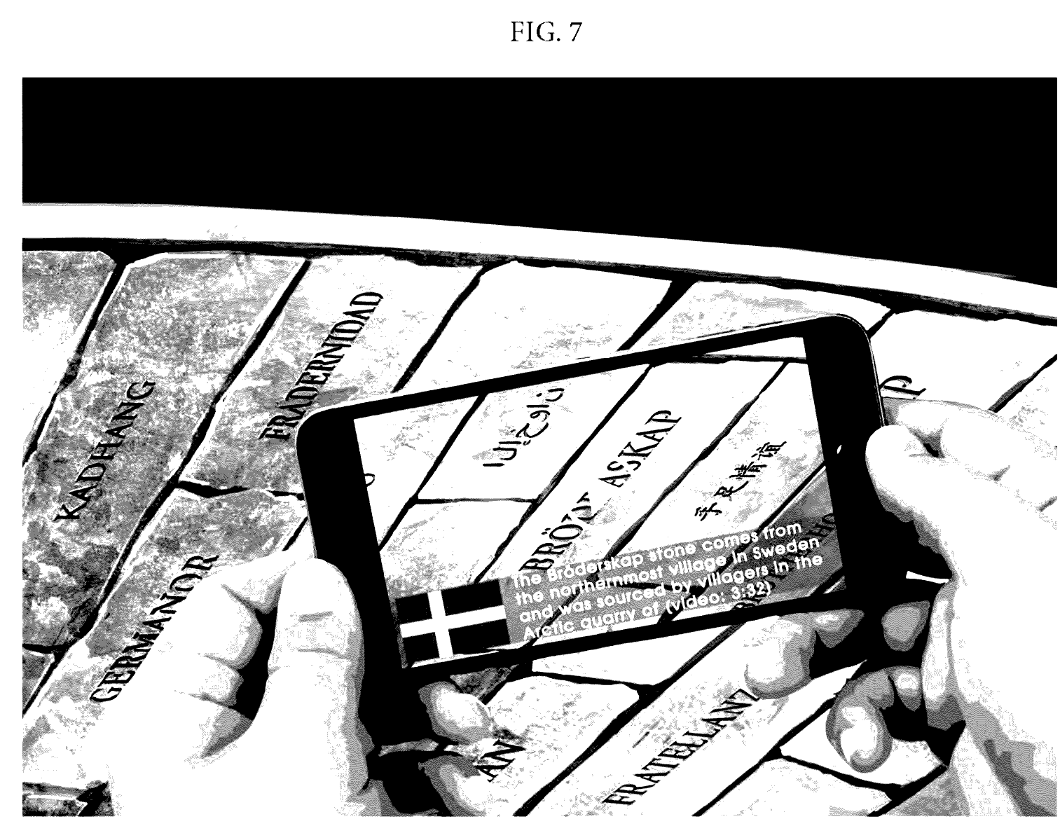

The disclosed invention can further include a corresponding mobile application that coordinates with and interacts with the table, visitors, and digital interface. Visitors to the table and surrounding area can download the corresponding mobile application, and the application can provide visitors with augmented reality viewing of the table itself, as illustrated in FIG. 7, as well as multimedia educational materials for each of the stones in the table.

In some embodiments, the mobile application can access a user's camera. Because the application is in sync with the digital interface, it allows for visitors to more directly send photographs and messages located on the user's phone to the digital interface via the application, so the photographs and/or messages can immediately appear on the digital walls that surround the table. These photos can also be instantly available for upload to social media websites such as Facebook, Twitter, and LinkedIn. By accessing a user's camera, the mobile application also enables visitors to use their phones' camera to photograph a stone and request additional information from the mobile application. For example, a user can photograph a stone and upload the photograph into the application, and the application can recognize the photographed stone and provide information to the user.

The mobile application can also freely feed updated video content, such as documentary films, news, and interviews, to all users who have downloaded it. In that sense, the mobile application can become an enduring media distribution channel.

As described above, the mobile application allows visitors to view the table through the lens of augmented reality. In one embodiment, an individual can view a virtual version of the table that is stored on a database within the mobile application. In another embodiment, each stone can be recognized by the mobile application when a user uploads a photograph of the stone to the mobile application. After the mobile application recognizes a stone, it can trigger a video about the respective country. The video can contain educational information about the country and a background on the country's participation in the creation of the table. The mobile application can also trigger text to pop up that educates the visitor on the stone and its country of origin.

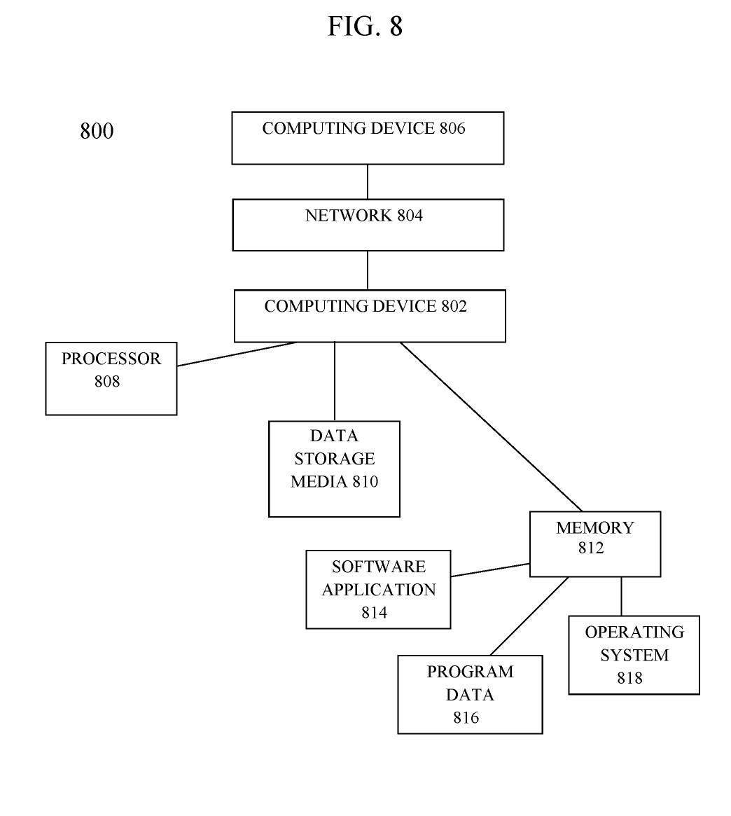

In some embodiments, the system described herein uses a computing system to carry out the various functions described herein. FIG. 8 is a schematic block diagram of an example computing system 800. The example computing system 800 includes at least one computing device 802. In some embodiments the computing system 800 further includes a communication network 804 and one or more additional computing devices 806 (such as a server).

The computing device 802 can be, for example, be a computing device 802 located in a user's home, school, or other place of business. In some embodiments, computing device 802 is a mobile device. The computing device 802 can be a stand-alone computing device or a networked computing device that communicates with one or more other computing devices 806 across a network 804. The additional computing device(s) 806 can be, for example, located remotely from the first computing device 802, but configured for data communication with the first computing device 802 across a network 804.

In some examples, the computing devices 802 and 806 include at least one processor or processing unit 808 and system memory 812. The processor 808 is a device configured to process a set of instructions. In some embodiments, system memory 812 may be a component of processor 808; in other embodiments system memory 812 is separate from the processor 808. Depending on the exact configuration and type of computing device, the system memory 812 may be volatile (such as RAM), non-volatile (such as ROM, flash memory, etc.) or some combination of the two. System memory 812 typically includes an operating system 818 suitable for controlling the operation of the computing device 802, such as the WINDOWS® operating systems or the OS X operating system, or a server, such as Windows SharePoint Server. The system memory 812 may also include one or more software applications 814 and may include program data 816.

The computing device 802 may have additional features or functionality. For example, the computing device 802 may also include additional data storage devices 810 (removable and/or non-removable) such as, for example, magnetic disks, optical disks, or tape. Computer storage media 810 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 810 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 802. An example of computer storage media 810 is non-transitory media.

In some examples, one or more of the computing devices 802 and 806 can be located in an establishment. In other examples, the computing device 802 can be a personal computing device, such as a personal computer or gaming device, that is networked to allow the user to access and utilize the system disclosed herein from a remote location, such as in a user's home, office or other location. In some embodiments, the computing device 802 is a smart phone, tablet, laptop computer, smart TV, personal digital assistant, or other mobile device. In some embodiments, system operations and functions are stored as data instructions for a smart phone application. A network 804 facilitates communication between the computing device 802 and one or more servers, such as an additional computing device 806, that hosts the system. The network 804 may be a wide variety of different types of electronic communication networks. For example, the network 804 may be a wide-area network, such as the Internet, a local-area network, a metropolitan-area network, or another type of electronic communication network. The network 804 may include wired and/or wireless data links (such as through 3G or 4G networks). A variety of communications protocols may be used in the network 804 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 806 is a Web server. In this example, the first computing device 802 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 808 of the one or more computing devices 802 or 806, the instructions cause the processor 808 to perform one or more of the operations or methods disclosed herein.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. An interactive table comprising:
a plurality of engraved, textured stones; and
a mobile application;
wherein the mobile application:
provides a user with augmented reality viewing of the table and educational information on each textured stone that is part of the table; and
receives uploaded content from the user and triggers a display of the content.
